(19) United States
(12) Patent Application Publication
(10) Pub. No.: US 2003/0028415 A1
(43) Pub. Date: Feb. 6, 2003

(54) E-commerce system using modeling of inducements to customers

(75) Inventors: Edmond Herschap III, Austin, TX (US); Timothy J. Magnuson, Austin, TX (US); Thomas J. Traughber, Austin, TX (US); Kasey White, Cedar Park, TX (US)

Correspondence Address: HOWISON, THOMA & ARNOTT, L.L.P, P.O. BOX 741715, DALLAS, TX, 75374-1715, US

(73) Assignee: Pavilion Technologies, Inc.

(21) Appl. No.: 10/053,527

(22) Filed: Jan. 18, 2002

Related U.S. Application Data
(60) Provisional application No. 60/262,935, filed on Jan. 19, 2001.

(51) Int. Cl. G06F 17/60

(52) U.S. Cl. 705/10

(57) ABSTRACT

An E-Commerce system using modeling of inducements to customers. A potential user is interfaced with a commerce site to receive information therefrom during a commercial transaction. A commerce model of a commerce system is provided that predicts as an output a defined commercial result as a function of information related to the user when in the commerce transaction and also as a function of inducements that can be provided to the user during the commerce transaction. The inducement input to the commerce model is varied to vary the predicted output of the commerce model in a predetermined manner until a desired predicted output of the commerce model is achieved. This varied inducement is then provided to the user during the commercial transaction.

### CROSS REFERENCE TO RELATED APPLICATIONS

This application claims priority to provisional U.S. Application Serial No. 60/262,935, filed Jan. 19, 2001 and entitled “E-COMMERCE SYSTEM USING MODELING OF INDUCEMENTS TO CUSTOMERS.”

### TECHNICAL FIELD OF THE INVENTION

This present invention pertains in general to E-Commerce systems and, more particularly, to a system that provides a closed loop predictive system for predicting inducements in response to a user input to the system.

### BACKGROUND OF THE INVENTION

When dealing in commercial transactions, especially those involving a purchaser of a product and a profit oriented system, various business models are well known. Primarily, those business models use some type of inducement to the user in order to achieve a desired commercial result. This commercial result can be multifaceted; it can be directed toward a profit based aspect, it can be directed toward a market share aspect or it could even be directed toward increasing sales of a non-related product. For example, if a retail store provides a discount on a particular product that is discounted below the price of a competitor product, one would expect sales to increase, a rather simple and straightforward precept. Although this would reduce the profit margin on a per item basis, the overall profits would increase due to the increase in sales. Alternatively, it is possible to reduce the profit margins to zero or even a negative profit margin to increase the market share on a temporary basis and then increase a profit margin over time. Again, these are conventional business models that are used to achieve a desired commercial result.

Commercial transactions presently has seen a substantial move from the conventional retail/catalog arena to the global communication network (GCN), generally referred to as the Internet. In this type of commerce, which is referred to as “E-Commerce,” the user purchases items via their personal computer over a network connection. This purchase involves the user interconnecting their computer with a E-Commerce Web server at a remote vendor site over the GCN and then receiving information about desired products. When a particular product is viewed that is desirable to the customer, the user then completes the transaction by purchasing the item via some type of credit card transaction, or even with a COD transaction. This involves the use of some type of server on the GCN by the vendor and, in addition, some type of delivery system. All of this results in a total closed loop system with the user interconnecting to the vendor, the vendor completing the transaction and then delivering the product to the user.

In addition to profits derived from the purchase of the items, there are numerous other ways the vendor can increase their profits as a result of utilizing an E-Commerce system. This can be in the form of advertising wherein certain advertisements are displayed to the user during the purchasing operation. For each “hit” to the website of the vendor, the advertisers are charged a finite sum of money.

### SUMMARY OF THE INVENTION

The invention disclosed and claimed herein comprises a method for conducting commerce. A potential user is interfaced with a commerce site to receive information therefrom during a commercial transaction. A commerce model of a commerce system is provided that predicts as an output a defined commercial result as a function of information related to the user when in the commerce transaction and also as a function of inducements that can be provided to the user during the commerce transaction. The inducement input to the commerce model is varied to vary the predicted output of the commerce model in a predetermined manner until a desired predicted output of the commerce model is achieved. This varied inducement is then provided to the user during the commercial transaction.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a block diagram of an overall system diagram for the E-Commerce system of the present disclosure;

FIG. 2 illustrates a simplified block diagram of the E-Commerce system;

FIG. 3 illustrates a detailed block diagram of the modeling/optimization portion of the system;

FIG. 4 illustrates a block diagram of the E-Commerce system illustrating the run time pre-process operation operating on the user data;

FIG. 5 illustrates a flowchart depicting the optimization operation;

FIG. 6 illustrates a block diagram of the training operation for the E-Commerce system;

FIG. 7 illustrates a diagrammatic view of the inputs to the E-Commerce system model;

FIG. 8 illustrates a flowchart of the data collection operation; and

FIG. 9 illustrates a flowchart for the training operation.

### DETAILED DESCRIPTION OF THE INVENTION

Referring now to FIG. 1, there is illustrated an overall diagrammatic view of an E-Commerce system operating in accordance with the present disclosed embodiment. The E-Commerce system in the present embodiment is generally comprised of an E-Commerce site 10 that is operated by a vendor, in one example, and a user that has access to a user's personal computer 12 at a remote location from the E-Commerce site 10. The user's computer 12 is operable to interface through a network interface 14 to a global computer network (GCN) 16. The GCN 16 is operable to interface with various remote locations on the web, one of which is the E-Commerce site 10. This interface to the E-Commerce site 10 from the GCN 16 is effected through an interface 18, similar to the interface 14.

The connection of the user through the user computer 12 to the E-Commerce site 10 is effected in a conventional manner. The user computer 12 typically has provided therein a program database 22 which has associated therewith various “browser” programs. These browser programs allow the computer 12 to interconnect to the GCN 16 for the purpose of transferring information to and from the GCN 16. This is effected through the use of a network address in the form of a “Universal Resource Locator” (URL). The user computer 12 obtains the URL and transmits this URL to the GCN 16 through the interface 14. This interface 14 typically is part of the GCN 16 and typically comprises an Internet Service Provider (ISP). The ISP that forms part of the interface 14 will service the received URL, look up the URL in its local database to determine how to route the information from the user computer 12 to the GCN 16 and then route the information to the correct location. The GCN 16 is basically a network of distributed computers and, therefore, the exact path through the network is not known. Additionally, the information that is transmitted from the interface 14 to the GCN 16 contains return address information such that the destination location has information on the GCN 16 as to how to return information to the user computer 12.

Typically, this URL is obtained through the use of a “domain” name. This domain name is a sequence of characters that can be transmitted to the interface 14, to the of the associated ISP, and then this is automatically transmitted to a domain name server (DNS) (not shown) located on the GCN 16. This DNS will determine what the URL for that domain name is from the look up table and then return it to the program operating on the user computer 12. The user computer 12 then utilizes this URL as described hereinabove. The ISP at the user site of the GCN 16 will transmit the information via the URL or network address to the E-Commerce site 10, this typically being effected through an ISP that forms part of the interface 18, this ISP being associated with the E-Commerce site 10.

Typically, communication is effected over the GCN 16 via some type of network protocol. This network protocol typically utilizes a TCP/IP protocol, a conventional protocol. This involves packets of data. These packets of data are transmitted with the address of the E-Commerce site 10 as the destination address from the user site to the E-Commerce site 10. A portion of this packet includes the source address of the user computer 12. Typically, this is a dynamic address provided by the ISP in interface 14. When the E-Commerce site 10 returns information to this address, the ISP in interface 14 recognizes this and forwards it to the user computer 12. Of course, once a user computer 12 logs off or disconnects from the interface 14, the dynamic address will be destroyed and this address will basically not exist on the network. It should be understood that, although this is being described as a general distributed network in the form of the GCN 16, any type of network is anticipated for use with the E-Commerce system. This could be an intranet, a wide area network or local area network. The GCN 16 is merely a way to allow the user computer 12 to interface with the E-Commerce site 10. Additionally, some type of multiple user network is anticipated since this will require multiple users to have access to the E-Commerce site 10. Of course, the system could work with a single computer wherein multiple users can gain access to the E-Commerce site 10 through the single computer. It is the access of multiple users through the E-Commerce site that is the subject of the present disclosure.

The E-Commerce site 10 is operable to interface with the user and receive a request therefrom. Typically, the first request is one that requests general information. The user will typically have some type of identification number (ID) that is transmitted to the E-Commerce site 10. The E-Commerce site 10 will have some type of E-Commerce database 24 that will store profile information associated with the user. This profile information can be information that is directly input by the user or it can even be information relating to prior purchases or transactions carried on by the user. In any event, whenever a particular user accesses the E-Commerce site 10, this is recognized by the E-Commerce site 10 and information extracted from the E-Commerce database 24 for use in the commerce transaction with the user. One method of doing this is assigning “cookies” to the user computer 12 and associated with the browser program at the user computer 12, which are downloaded to the user computer 12 from the E-Commerce site 10. These are stored therein such that, upon later access to the E-Commerce site 10 by the user, this cookie can be retrieved by the interface to the E-Commerce site 10 to allow the E-Commerce site 10 to gain some information as to the user. Of course, this information actually relates to the user computer 12 and not to the actual users themselves, such that if a second user were to log onto the user computer 12 utilizing the same web browser, the E-Commerce site 10 would recognize this other user as the first user. However, each user computer 12 can have a different log on computer profile such that a separate set of “cookies” is provided for each user upon their log on.

Once the E-Commerce site 10 has recognized the user, information is forwarded back to the user regarding available items in the example commerce transaction. Typically, based upon the particular profile stored in the E-Commerce database or other information stored therein, this return information can be customized to the user. This customization can be directed toward such things as advertisements for defined targeted goods that will be directed toward the user based upon prior history of purchase or even based upon a profile that the user provided.

Once the requested information is transmitted back to the user, the user will possibly select some desired commercial transaction and complete that transaction. This could be merely the purchase of an item. In the present embodiment, the purchase of an item is the example utilized.

Once the transaction is complete on the user's side, the E-Commerce site 10 will record this transaction by an update in the database 24 and then it will complete the transaction. In the present disclosed embodiment, this completion is the transfer of product. This will necessitate the E-Commerce site 10 accessing an inventory site 28 to delivery inventory to the user via some type of delivery service 30, via some type of delivery path 32. This could be a courier, the U.S. Post Office, or similar type of delivery mechanism. E-Commerce sites in use today deliver anything from jewelry to major electronic equipment.

During the transaction, the E-Commerce site 10 will typically require some type of contemporaneous payment, assuming that the user does not have some type of account with the E-Commerce site 10. In this situation, there will typically be some type of credit card or financial transaction required. This, in the case of a credit card, will require a verification. This verification can be done though a credit card company 36 located at a remote site. This remote site can interface with the GCN 16 through an interface 38 similar to the interfaces 14 and 18, to receive information from the E-Commerce site 10 regarding a potential transaction. Of course, this type of transaction is typically referred to as an “unsecured” communication. These are typically frowned on in this type of commerce situation, although regulations and technology may allow this to be a “secured” communication path. At present, a secured transaction will typically be effected over a Public Telephone Network (PTN) 40 to the credit card company 36. The E-Commerce site 10 would, after receiving a completion of the transaction from the user, access information at the credit card company 36. Upon access of the information and a validation therefrom, then the E-Commerce site 10 would complete the transaction by delivering the desired goods, services, or etc. to the requesting user.

As will be described in more detail hereinbelow, the transfer of information to the user is controlled by an E-Commerce model/optimizer operation depicted in a block 40. This optimizer will optimize the interface with the user by the E-Commerce sites based upon a model of an E-Commerce system that will yield a desired commercial result. The vendor at the E-Commerce site 10 can set desired parameters for the commercial result and optimize the interface with the user in the form of inducements provided to the user, etc., to optimize the commercial result.

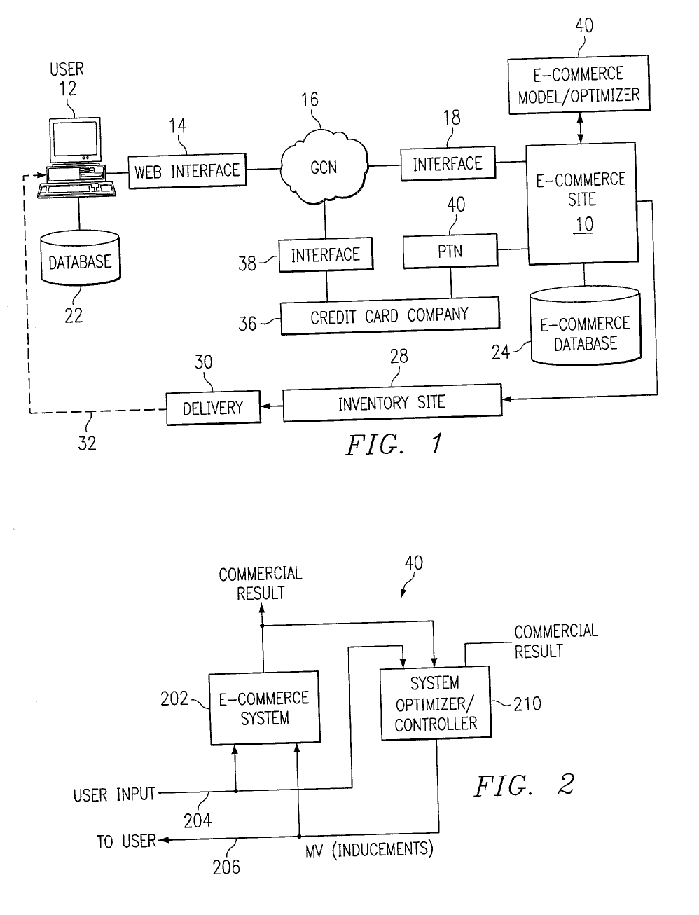

Referring now to FIG. 2, there is a simplified block diagram of the overall E-Commerce system described hereinabove. In general, there is provided an E-Commerce system 202, which basically involves the entire network, database, delivery system, etc. for effecting a commercial transaction. The E-Commerce system is operable to receive input from the user on a line 204. This is basically the connection between the user PC 12 and the E-Commerce 10 through the GCN 16. This allows the user to provide input thereto. The E-Commerce system 202 is also operable to operate on various inducements which basically are generated and forwarded to the user on a line 206. These inducements are referred to the system as “Manipulatable Variables” (MV). They are referred to as manipulatable variables due to the fact that they can be altered and they are the one control aspect that can define the results of the E-Commerce system 202, i.e., the commercial result. The overall system described herein in accordance with one embodiment utilizes a system optimizer/controller 210 to basically determine what the inducements would be that are provided to the user to achieve the desired commercial result. To determine this, this system optimizer/controller 210 will receive the “actual” commercial results from the E-Commerce system 202, the user input and also a desired commercial result. Depending upon what this desired commercial result is, the MVs will be optimized to provide the best commercial result. These optimized MV's are then input back to the user on the line 206.

As an example of the operation, the user may input their user information to the E-Commerce system 202 and then the system optimizer/controller 210 analyzes that information and possibly change the inducement. If the user, in one transaction, was purchasing books and was continuing to use the site to place the books in their “basket,” the system would recognize the user's potential purchase. The term “basket” is referred to as the accrual of the user's potential purchases, i.e., the user's shopping list. For example, the user could select five books and place these in their “basket” and, after completion of their choices, complete the transaction by electing to purchase the books therein. Of course, the total system recognizes that there are now a defined number of books in the basket and the type of books that are in the basket, i.e., the commerce system is aware of the decision making at each step of the commerce transaction to some extent. This can be based on only what the user is contemplating purchasing or it can be based upon a previous history of the user. The inducement may have been learned and a representation thereof stored in the system optimizer/controller 210 to indicate that the user should be presented with the option of a discount if he/she purchases one more book. If, for example, this threshold was at five books, the system would recognize that a large number of purchasers similar to the current user will respond to a five percent discount when selecting five books such that an additional book would be purchased. It may be that the system wants to optimize on profits and the previous history learned by this system optimizer/controller 210 indicates that a desired increase of profits by 1% requires only a 5% discount to be provided to this particular user purchasing five books in order to provide the incentive to that purchaser to purchase another book. However, if the commercial result were to increase profits by 3%, it may be that the system would provide a 10% discount as an incentive to that particular user. This, as will be described hereinbelow, is a learned behavior.

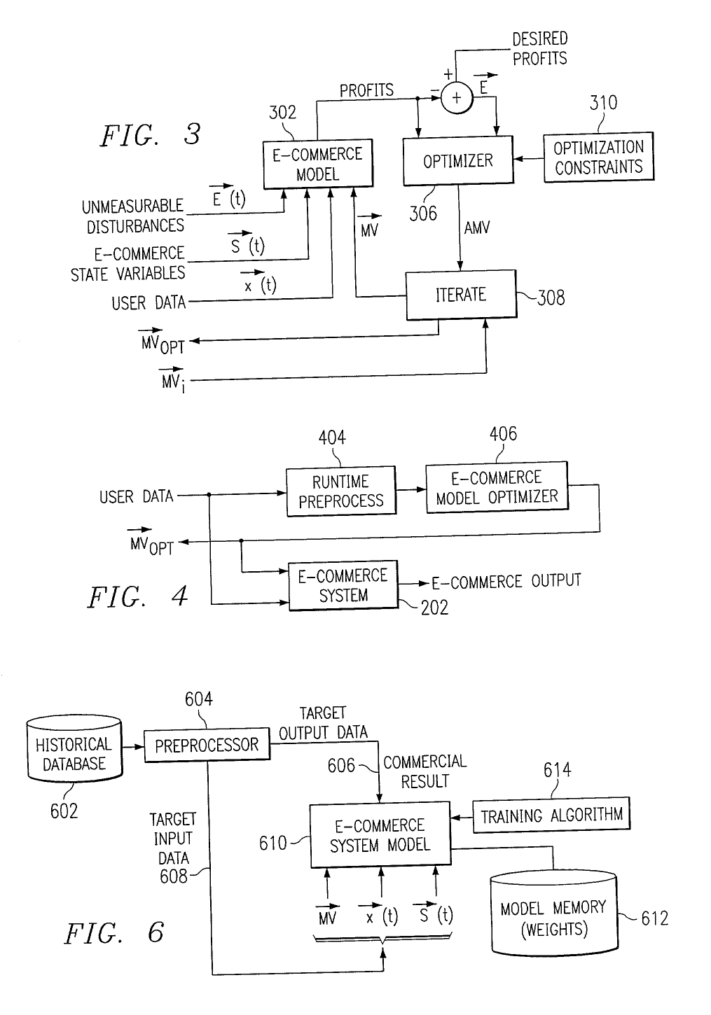

Referring now to FIG. 3, there is illustrated a more detailed block diagram of the system optimizer/controller 210. Overall, E-Commerce system 202 is represented by a nonlinear model 302, which nonlinear model can be realized with a neural network. Such a system is described in U.S. Pat. No. 5,353,207, issued Oct. 4, 1994, which is incorporated herein by reference. The neural network includes an input layer and an output layer with a hidden layer disposed therein, which hidden layer basically contains a stored representation of the overall operation of the E-Commerce system. This stored representation is a learned representation and represents a function. In the disclosed embodiment of FIG. 3, this is the commercial result which is defined as profits, for exemplary purposes. In general, this commercial result, i.e., profits, is a function of various things that happen to the system. The inputs that define the operation of the system will be such things as cost of products, type of products, etc., these being determinable variables which are referred to as state variables in the system, represented by a vector s(t). This, in addition to the user data, represented by a vector x(t), and the manipulatable variables MV. These represent the determinable variables, the user input variables and the inducement variables that are generated by the system to provide an inducement to the user. In addition to these determinable variables, input variables and manipulatable or control variables, there is also provided a vector E(t) representing unmeasurable disturbances to the system. These unmeasurable disturbances are disturbances that cannot be measured and affect the integrity of the model. They may be such things as a change in the overall buying public's attitude due to unknown circumstances. For example, a vendor may have a product in the marketplace that has been selling at a steady rate and is the subject of well known inducements in order to increase sales, increase profits, etc. However, something external to the system may effect how the buying public views this product. For example, if an unexpected market disturbance occurs that effects the sales of this product that cannot be anticipated or that was not learned, this would constitute an unmeasurable disturbance. On example of this in recent history was a news article indicating that a flight attendant on a major airline had purchased a large number of rolls of toilet tissue due to the fact that there was an impending shortage in the United States of this product. Somehow this news traveled very rapidly through the media, and the buying public immediately panicked and purchased excessive quantities of this product. As a result, the store shelves became depleted and this whipsawed on the system such that the manufacturers were required to manufacture more product to keep the store shelves full and the such. Additionally, things such as earthquakes and natural disasters will effect the buying public's perception of a product. These types of things cannot be learned, since they are due to an unmeasurable disturbance that occurs to the overall commercial transaction operation. The method of incorporating those disturbances into a network is facilitated through the use of a residual activation neural network, the subject of U.S. Pat. No. 5,353,207. This is basically facilitated through the utilization of a model that stores a representation of the dependency of the manipulatable variables on the known state variables or measurable variables. A predicted result is then subtracted from the actual state variables that are input and stored as a residual. The output of this residual layer is then utilized to facilitate modeling of the unmeasurable disturbances.

The output of the E-Commerce model 302 is input to an optimizer 306, which is operable to also receive the difference between the predicted output from the model 302 and a desired value for profits. This difference is referred to as an error vector, E, which is input to the optimizer 306. Utilizing this information, the optimizer can generate a ΔMV. This optimizer utilizes an inverse representation of the model 302 wherein the error is back propagated through the original model with the weights of the original predictive model frozen. This back propagation of the error through the network is similar to an inversion of the network with the output of the plant representing a new value utilized in a gradient descent operation. This is provided by an iterate block 308. This operation is described in U.S. Pat. No. 5,353,207, which was incorporated herein by reference hereinabove. Iterate block 308 in general initially receives a manipulatable variable vector MVᵢ that represents an initial value for the manipulatable variables. These are inputs of the system and a predicted output provided by the model 302. An error is determined based upon the set of optimization constraints in a block 310. The optimizer will determine, based upon the error between the desired profits and the predicted profits, an error value which will be utilized by the optimizer to generate the ΔMV. This is then input to the iterate block 308 and this subtracted from the previous value in iterate block 308. This previous value, changed by the value ΔMV is then input back to the model 302 to generate a new predicted value. This continues until an optimized value is reached. Once the optimized value is determined, this provides an output MV_{OPT} which is output to the user. The general terminology for the operation of back propagating the error for purposes of generating an overall “control” loop to provide an optimized manipulatable variable is “Back Propagation-to-Activation” (BPA).

In the preferred embodiment, the method utilized to back propagate the error through the plant model 302 or through the optimizer 306, which represents the inverse of the model 302, is to utilize a local gradient descent through the network from the output to the input with the weights frozen. The first step is to apply the present inputs for the manipulatable variables, the user data, the state variables and the unmeasurable disturbances to the model 302 to generate a predicted profit value, P^{P}(t). The value of ΔMV is equal to the new value thereof input to the model MV(t+1) minus the input value MV minus an adjustable step size parameter, which determines how much it changes per each increment. The output is then regenerated from this new value and the gradient descent procedure is iterated.

As noted hereinabove, this inverse plant model in the optimizer 306 utilizes a residual activation network for the purposes of projecting out the dependencies of the controller of the manipulatable variables on the determinable state variables. In this manner, the network incorporated in the optimizer 306 will pay appropriate attention to the manipulatable variables and generate the desired inducements for output to the user.

The system of FIG. 3 is a system based upon a linear or non-linear model, in the form of model 302 and also in the form of the inverse model in the optimizer 306, that provides the commercial result, i.e., profits in the present example, defines the profits as a function of the inputs by the following relationship:

Profits=f(\vec{s}(t),\vec{x}(t),\vec{E}(t),\vec{M}\vec{V})

However, this function only represents the dependencies of the output on the inputs to the model 302. There are also dependencies between the various inputs, these specifically being the inputs x(t) and MW. Therefore, there will be a dependency that is as follows:

\vec{M}\vec{V}=f(\vec{x}(t))

The model 302 therefore will provide a model of the dependencies between these two inputs.

Referring now to FIG. 4, there is illustrated a block diagram of the overall system with the addition of a run time preprocess block 404 that is disposed between the input of the user data to the E-Commerce model/optimizer, represented by block 406 which generally represents the optimizer 210 that optimizes and outputs the optimized value for the manipulatable variables. The run time preprocess block 404 is basically an operation wherein user data is modified to fill in the “holes.” For example, if a user were to provide user information that left out certain fields, this would possibly constitute missing data to the model 302. With a missing field, the model 302 would initially set this value to a null value or a “zero” value. This would affect the integrity of the prediction. Therefore, it is desirable to have some type of value placed therein to enhance the prediction. This could be an average value or it could be predicted by various operations. In general, the operation of the run time preprocess block 404 is described in U.S. Pat. No. 5,729,661, incorporated herein by reference. In general, the system operates by reconciling a missing current value with information regarding past value. Overall, the desired new value to be replaced is a function of all of the previous raw values stored in the database which raw values can then be extrapolated. This can utilize any type of extrapolation algorithm that utilizes the past values. For example, a linear extrapolation, could be used in addition to a polynomial, spline-fit or neural network extrapolation techniques. (See eg. W.H. Press “Numerical Recipes,” Cambridge University Press (1986) pp. 77-101). Additionally, when training the network from a historical database, it is necessary to utilize the extrapolated data for the purpose of training, assuming that some of the historical data is not complete as to all desired fields.

Referring now to FIG. 5, there is illustrated a flowchart depicting the overall operation of the commercial transaction. The program is initiated at a block 502 and then proceeds to a function block 504. At the function block 504, the operation is indicated wherein the user has generated an initial request to the E-Commerce system. This initial request is basically accessing the vendor web page. During access of the web page, the E-Commerce system receives information from the user computer through access of a “cookie” from the user's computer 12 or this information is provided by the user. This information allows the user to be defined to the system, as indicated by the function block 506. The program then flows to a function block 508 wherein the database 24 is accessed for the purpose of updating the database with information on the user and also obtaining a user profile therefrom. For example, prior to inputting the user information into the E-Commerce model/optimizer 40 for generation of the inducements, it may be that additional information is provided by the user during access due to updating some type of internal profile to the user's computer 12 associated with their database 22. When this user information is provided, the user area of the database 24 will be updated for that user prior to providing overall information for the user. This profile that will be provided to the system will be in the form of the user name, address, location, various particulars about the individual(if provided) and also a history of their use at the vendor site. Further, it could be that other vendors have additional information regarding that particular user that could be added to this database. This could be a type of “universal” database that was provided through the use of some type of universal consumer number. In any event, there is provided some type of information regarding the user which will comprise an input to the system.

Once the user information is determined through either access of the database or access of information from the user's computer 12, this information is forwarded to the optimizer/controller 210 for the purpose of optimizing the inducement, as indicated by a function block 510. In general, the initial inducement is provided for a general user that has no information. This general inducement, MV_{i,} will then be optimized for whatever information is in the user's database. Even if the system was associated with a new user, it may be that one input associated with the optimization procedure is such things as the time of day, the location of the user or other information that may lead to an optimization operation. Basically, any information that is available about the commerce transaction is utilized to alter the base line manipulatable variables.

Once the inducements have been optimized and determined, the program proceeds to a function block 512 wherein this inducement is transmitted to the user and is displayed at the user's PC 12 on the associated display. The program then flows to a decision block 514 to await a reply from the user. The program will flow along the “N” path to a timeout decision block 516 to determine if a timeout period has occurred. If so, the program will flow along a “Y” path to an End block 518. If not, the program will continue to loop back to the input of the decision block 514. Once a reply has been received, this reply either associated with new information or with the completion of a transaction, the program will flow along a “Y” path to a decision block 520. At decision block 520, the decision block as to whether additional user information is provided, this being distinguished from information regarding the completion of a commerce transaction. If not, then this indicates that the transaction has been complete due to the input of credit card information followed by depression of a select field such as a “Send” field, to the vendor. This will result in the program flowing along the “Y” path from decision block 520 to a function block 522 to complete the transaction and then to an End block 524. If additional user information is provided in the form of selecting a product for entry into the user's “basket,” then the program will flow along the “Y” path from decision block 520 to a function block 526 to update the database and then return back to the inducement optimization block 510. They system will continually go through the optimization routine based upon data that is provided by user which can then be utilized to pull up correlating information from the database, this all constituting the user input information. This will continue until the transaction is complete.

By utilizing this looping technique wherein the inducements are optimized for each condition that exists in the transaction, the commercial result, i.e., the profits in this example, can be optimized for that particular situation. Referring back to the above described example wherein the user is selecting books, it may be that selection of five books in the “basket” would result in a certain discount being offered to induce that particular user to purchase another type of book. Further, it might be that the type of book being purchased or the value of that book will cause an inducement to be provided back to the user. This, however, must be distinguished from a conventional system wherein the inquiry by the user as to a price regarding one type of book results in advertisements or responses sent back to the user regarding general types of books. These are predetermined inducements that are the result of a “template” matching operation. There is no optimization provided therein that takes into account the interdependencies of a relationship between the inducements and the user information that are related to a predicted commercial result, which commercial result is optimized by manipulating the manipulatable variables, i.e., the manipulatable variables being the only controls that the system has to alter or vary the commercial result.

Referring now to FIG. 6, there is illustrated a block diagram for the training operation. In the training operation, historical database 602 is provided which represents historical input data regarding the user input data, the state variables and the manipulatable variables which have been taken over time with and associated with an actual commercial result, that being such things as profits, market share, etc., as described hereinabove. The data is extracted and subjected to a pre-process operation in a pre-processor 604 which is described in U.S. Pat. No. 5,729,661, incorporated hereinabove by reference. This pre-processor can fill in various holes and can also count for various delays if there are certain aspects of the data that requires a common time base. The pre-processor 604 will provide output data in the form of the commercial result on an output 606 and target input data in the form of the MV, x(t) and s(t) vectors on a target input line 608. The target input data is input to the input of an off-line E-Commerce system model which is basically an untrained neural network. The only thing that is necessary is that the weights of the model be trained, which weights are contained in a model memory 612. The weights define the representation that is stored in the hidden layer of the overall model. During training, a training algorithm, as indicated by a block 614, is utilized to determined the weights by back propagating the target data through the model to the input using such techniques as a gradient descent operation. In the deferred embodiment, the model 610 is a multi-layered neural network as trained on one of multiple training algorithms in the block 614. One of these training methods is Back Propagation wherein various weights within the network are set during the Back Propagation training operation. These weights are then stored as model parameters in the memory 612, this training operation and the neural network being conventional systems.

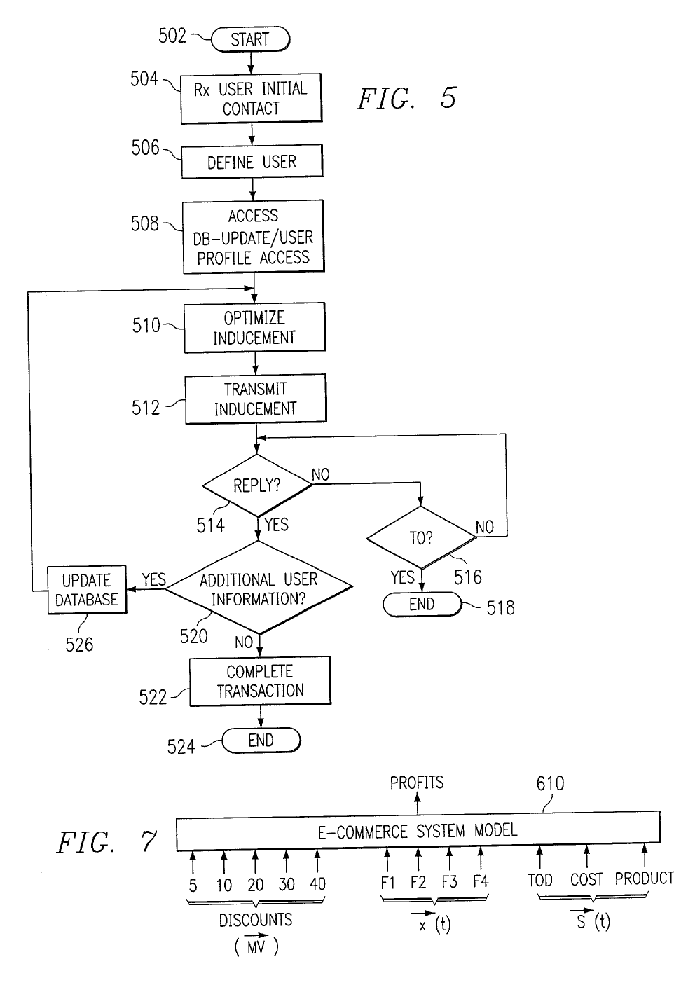

Referring now to FIG. 7, there is illustrated a diagrammatic view of the model 610 either before or after training showing detail of the inputs. This illustrates one example wherein discounts constitute the manipulatable variables. There are provided a plurality of inputs, one associated with one of different discounts. These can either be on or off, indicating which discount is active. The user inputs, x(t), are provided as a group of fields. The value of these fields, indicated as F1-F4 provide information that would be input through a field on the user's display or extracted from memory. Each of these represents a different variable or a different input. The state variables, s(t), can be such operations as time of day (TOD), cost and product. There could, of course, be other measurable variables that define the operation of the E-Commerce system. Additionally, it should be recognized that some of the measured variables are variables that the user selects. For example, when the product is selected, this could constitute a state variable that would have associated with it the cost of the product, the suggested retail price, the quantity in inventory, etc. However, the particulars about the user, i.e., sex, income level, demographics etc., would constitute a user input associated with either direct input by the user or information associated with the user profile. Additionally, the user might provide information as to the number of items in their “basket.” This would constitute a user input that is not a measurable variable but, rather, a user defined variable.

During training, as described above with reference to FIG. 6, the manipulatable variables, the discounts in this example, are the only thing that can be varied by the system. The other information is returned either by the user, or extracted from the database, or constitutes an input to the system model, such as the time of day. Therefore, by varying the discount levels in many different situations, a large amount of information can be collected and utilized to train the model.

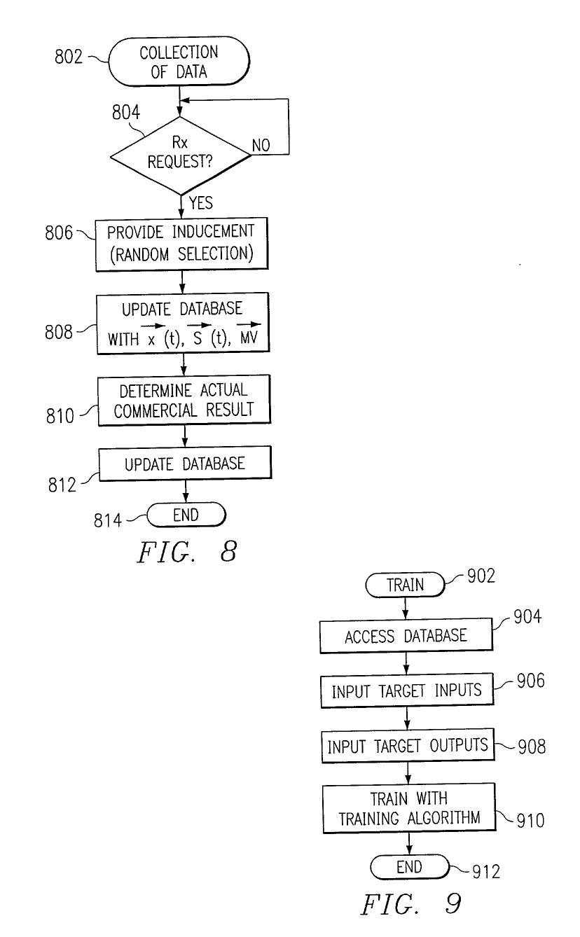

Referring now to FIG. 8, there is illustrated a flowchart depicting the operation of collection of data, as initiated a block 802. The program then flows to a decision block 804 to determine if a request has been received. When received, the program flows along a “Y” path to a function block 806 to basically provide the inducement to the user. It may be that the inducement is to make no change to the retail price and determine what type of transaction occurs. It may be that a 5% discount will be forwarded to the user. The only requirement is that a single inducement (assuming there is only one inducement) be provided to the user for a given variable. If, for example, there were multiple variables such as a discount, a free offer, future coupons, etc., there could only be one value or offer for each particular MV in the vector MV. This inducement is provided, for example, through random selection each time a user requests information. Alternatively, there could be a systematic input of the inducement, i.e., by providing a different discount for a large group of purchases incrementally.

After the inducement has been provided, the information in the database is updated, as indicated by a function block 808. This provides an update of the x(t), s(t) and MV vectors. The program then flows to a function block 810 to determine what the commercial result was, i.e., the actual commercial result, not the predicted commercial result. This is then stored in the database, as indicated by a function block 812, in association with the input information or variables that caused this result. The program then flows to an End block 814.

Referring now to FIG. 9, there is illustrated a flowchart depicting a training operation, which is initiated at a block 902 and then proceeds to a function block 904 to access information in the database, this being historical information associated with database 602. The program then flows to a function block 906 to input the target input data along the input 608 to the model and then to a function block 908 to input the target outputs along the line 606. Of course, these are pre-processed prior to input thereof, if necessary. The program then proceeds to a function block 910 to train the system with the training algorithm, this being a situation wherein multiple inputs are required for the training algorithm. Again, as described hereinabove, the training algorithm can utilize one of multiple training algorithms that are conventional. Once the training is complete, the program will flow to an End block 912.

Although the preferred embodiment has been described in detail, it should be understood that various changes, substitutions and alterations can be made therein without departing from the spirit and scope of the invention as defined by the appended claims.

What is claimed is:

1. A method for conducting commerce, comprising the steps of:
interfacing with a potential user to receive information therefrom during a commercial transaction;
providing a commerce model of a commerce system that predicts as an output a defined commercial result as a function of information related to the user when in the commerce transaction and also as a function of inducements that can be provided to the user during the commerce transaction;
varying the inducement input to the commerce model to vary the predicted output of the commerce model in a predetermined manner until a desired predicted output of the commerce model is achieved; and
providing the varied inducement from the step of varying to the user during the commerce transaction.

2. The method of claim 1, wherein the commerce transaction is an electronic commerce transaction.

3. The method of claim 1, wherein the step of providing a commerce model comprises providing a non-linear commerce model.

4. The method of claim 1, wherein the information related to the user comprises a history profile of the user stored in a database which is associated with the user and is accessed in response to the user being interfaced with.

5. The method of claim 1, wherein the information related to the user comprises information received from the user that constitutes a parameter of the commercial transaction.

6. The method of claim 1, wherein the step of varying comprises the step of optimizing the predicted output of the commerce model as a function of predetermined optimization criteria and wherein the step of providing the varied inducement comprises providing the optimized inducement to the user.

7. The method of claim 1, wherein the step of varying operates in response to interfacing with a potential user and receiving information therefrom.

8. The method of claim 1, wherein the commercial result comprises profit.

9. The method of claim 1, wherein the commercial result comprises market share.

10. The method of claim 1, wherein the step of varying the inducement comprises:
providing an inverse model, which inverse model comprises the inverse of the commercial model;
receiving on the output of the inverse model an error value determined as the error between a desired value and the predicted output of the commerce model and generating an increment to the inducement;
incrementing by the determined increment the input value to the commerce model of the inducement value;
iteratively processing information through the inverse model until the predicted output of the commerce model is within defined boundaries defined by predetermined optimization; and
providing the final iterated value of the inducement value as the varied inducement value to the user.

11. The method of claim 1, wherein the step of interfacing with a potential user comprises:
interconnecting through a global communication network from a user computer by the user to a remote location on the global communication network associated with a commerce site, which commerce site has associated therewith the commerce model and wherein the step of providing the varied inducement to the user comprises providing the varied inducement to the user over the global communication network.

12. The method of claim 1, further comprising the step of completing the commerce transaction by the user.

13. The method of claim 12 and further comprising the step of completing the commerce transaction wherein the commerce transaction requires delivery of goods or services and further comprises the steps of completing the transaction by providing from a vendor associated with the combined commercial result of the desired goods or services.

14. The method claim 1, wherein the commerce transaction includes the step of verifying the financial information which comprises a portion of the received information from the user during the step of interfacing.
